(19) United States
(12) Patent Application Publication
(10) Pub. No.: US 2026/0126068 A1
(43) Pub. Date: May 7, 2026

(54) AXIAL TOLERANCE COMPENSATION ARRANGEMENT, A CONNECTION BETWEEN TWO COMPONENTS WITH SAME AS WELL AS A CONNECTION AND A MANUFACTURING METHOD FOR SAME

(71) Applicant: Böllhoff Verbindungstechnik GmbH, Bielefeld (DE)

(72) Inventors: Gunnar LINDNER, Paderborn (DE); Sandra STEFFENFAUSEWEH, Verl (DE)

(21) Appl. No.: 19/380,446

(22) Filed: Nov. 5, 2025

(30) Foreign Application Priority Data
Nov. 6, 2024 (DE) 102024132374.4

(51) Int. Cl. F16B 5/02

(52) U.S. Cl. CPC F16B 5/025

(57) ABSTRACT

An axial tolerance compensation arrangement for the automatic compensation of tolerances between a first and a second component, including: a nut element with a radially outer fastening structure, which is fastenable in a component opening of the first component, and an inner nut thread of a first thread direction, a hollow screw with a head and a hollow-cylindrical shaft having an adjustment thread matching the nut thread at a radial outside and a fastening thread with a second thread direction opposite to the first thread direction at a radial inside. The fastening thread interacts with a fastening screw of a second thread direction so that the first and the second component are fastenable via the tolerance compensation arrangement, wherein the hollow-cylindrical shaft comprises a disassembling protection at an axial end which faces away from the head. The disassembling protection prevents unscrewing of the hollow screw from the nut element.

### 1. FIELD OF THE INVENTION

The present invention is related to an axial tolerance compensation arrangement for the automatic compensation of tolerances between a first and a second component, a connection between these two components with the help of the axial tolerance compensation arrangement, a respective connection method as well as a manufacturing method for the axial tolerance compensation arrangement.

### 2. BACKGROUND OF THE INVENTION

In the state of the art, different tolerance compensation arrangements are known, with the help of which two components are fastenable at a distance to each other. These tolerance compensation arrangements follow different technical principles.

DE 10 2010 048 239 A1 describes a first component with a hollow cylindrical fastening recess. A tolerance compensation sleeve may be slid into this fastening recess. Subsequently, a fastening screw is screwed through an opening of a second component into this tolerance compensation sleeve. The tolerance compensation sleeve widens radially due to this screwing process, that way clamping itself in the fastening recess of the first component. At the same time, the second component is pulled against the tolerance compensation sleeve in order to establish the connection between the first and the second component.

According to the technical teaching of the European patent application 0 414 162 A1, firstly, an anchoring part with a hollow shaft is arranged in the opening of the first component. Then, a distance piece is screwed into this hollow shaft by means of a thread until it compensates an existent distance between a first and a second component. By screwing-in the fastening screw through the opening of the second component into the distance piece, the distance piece is expanded like a dowel. That way, on the one hand, the fastening of the second component to the distance piece which is anchored in the anchoring arrangement and a clamping, radial expanding of the distance piece takes place so as to fix the adjusted tolerance between the first and the second component. This construction is quite laborious, as for example, no automatic tolerance compensation while screwing-in the fastening screw takes place. Rather, firstly, the anchoring piece is to be fastened in the first component and then, the distance piece is to be adjusted to the distance to be compensated between the component by screwing in the same thread direction as the fastening screw. Subsequently, it can happen during screwing-in the fastening screw that the distance piece screwed further into the anchoring piece so that the tolerance to be compensated of the tolerance compensation arrangement is reduced again. Thus, the disadvantages of this arrangement are not only the number of parts but also the kind of application, which increases the cycle time for establishing a connection between two components.

In order to realize an independent axial tolerance compensation between two components during them being connected, the state of the art suggests tolerance compensation arrangements where thread pairings of a different thread direction and a dragging element are combined with each other. This is for example described in EP 2 049 807 B1, DE 10 2020 216 324 A1, EP 1 780 424 A1. In particular, the integration of the dragging arrangement into two interconnected thread sleeves with different thread pairings increases the manufacturing effort of such axial tolerance compensation arrangements, as often, the dragging element is made of another material than the thread sleeves which are to be connected with one another. Nonetheless, the advantage of these arrangements is that they can be integrated into the connecting process without any additional installation effort as while fastening the components which are at a distance to each other, the tolerance compensation arrangement compensates the distance between the two components in a supportive, independent and subsequently mechanically loadable manner.

The European patent EP 1 304 489 B1 further simplifies such known axial tolerance compensation arrangements with automatic tolerance compensation, as the disclosed tolerance compensation arrangement is only comprised of a screw, a nut and a compensation bushing. The screw, the nut and the compensation bushing are configured so that they have a right-handed thread pairing and a left-handed thread pairing. Furthermore, the compensation bushing includes a clamping portion which can enter into a friction fit with the screw. This measure leads to the screw corotating the compensation bushing due to the friction fit first and thus screwing it out of the nut against the insertion direction until the compensation bushing attaches the first component after the completed tolerance compensation. After that, the screw is then screwed together directly or indirectly with the nut while overcoming the friction fit. Thus, the advantage of this construction is that no additional dragging element, for example made of a further material, needs to be integrated into the tolerance compensation arrangement during the manufacturing process. Rather, the tolerance compensation arrangement is made of metal and can be manufactured as one piece.

The above-described tolerance compensation arrangements with automatic tolerance compensation function do, however, all have the same disadvantage that in case of a too large distance, which is not recognized by a mechanic, between the two components which are to be fastened to each other, the compensation sleeve can be screwed out of the fastening thread. The reason is that the fastening automatism of such tolerance compensation arrangements assumes that the tolerance to be compensated between the two components can be realized without any further ado by means of the telescopic-like unscrewing of the tolerance compensation arrangement. In case, however, this spacing is too large for the bridgeable distance of the tolerance compensation arrangement, both thread sleeves are unscrewed beyond their threaded engagement so that the tolerance compensation arrangement loses its bond. This leads to additional work steps as beside the further correction of the distance between the two components, a new tolerance compensation arrangement must also be provided and the old tolerance compensation arrangement with fastening screw must be released from the first component, first.

The object of the present invention is therefore to adapt known tolerance compensation arrangements so that a too large distance between two components to be fastened to one another does not lead to a loss of the tolerance compensation arrangement arranged in between. Rather, the tolerance compensation arrangement should be capable of not losing its integrity even if the axial tolerance which is to be bridged is too big.

### 3. SUMMARY OF THE INVENTION

The above object is solved by a tolerance compensation arrangement according to independent claim 1, by a connection between a first and a second component with the tolerance compensation arrangement according to independent claim 10, by a connection method of two components with this tolerance compensation arrangement according to independent claim 12 and by a manufacturing method of the above-mentioned tolerance compensation arrangement according to claim 13. Advantageous configurations and further developments of the present invention arise from the following description, the accompanying drawings and the dependent claims.

The present invention discloses an axial tolerance compensation arrangement for the automatic compensation of tolerances between a first and a second component, having the following features: an annular nut element with a radially outer bayonet structure, which is fastenable in a key hole of the first component, and an inner nut thread of a first thread direction, a hollow screw with a head and a hollow-cylindrical shaft having an adjustment thread at a radial outside matching the nut thread and a fastening thread with a second thread direction opposite to the first thread direction at a radial inside, wherein the fastening thread interacts with a fastening screw of a second thread direction so that the first and the second component are fastenable to one another by means of the tolerance compensation arrangement, wherein the hollow-cylindrical shaft comprises a protection against disassembling at an axial end which faces away from the head, wherein with the disassembling protection the hollow screw is prevented from being screwed out from the nut element during an installation of the tolerance compensation element.

The present invention provides an axial tolerance compensation arrangement which, on the basis of two thread pairings of a different thread direction, provides an automatic tolerance compensation when being installed between two components that are spaced from one another. In order to simplify and thus accelerate the establishment of this connection between the two components already at the beginning of the installation process, the nut element for receiving the tolerance-compensating hollow screw is anchored in a keyhole geometry or keyhole of the first component. That way, a resilient thread basis is created with the help of the nut element and the bayonet lock to the first component or bayonet connection to the first component used in combination with same so as to be able to fasten the second component at a specific distance to it. This fastening process of the nut element with bayonet structure, which most of the time only requires a quarter turn, is easier than for example the use of a blind rivet nut or a welding nut in terms of manufacturing and application, in order to be able to establish a connection between two components.

In order to compensate the existing distance between the two components, a hollow screw is arranged, preferably pre-installed, in the nut element. In its axial extension, this hollow screw comprises the above-mentioned disassembling protection at an axial end opposite the head. With regard to its constructive function, this disassembling protection is intended to disturb the thread pairing between the hollow screw and the nut element at the end of the process of unscrewing the hollow screw from the nut element to such an extent that this unscrewing process cannot be completed. Thus, the disassembling protection guarantees in a constructive way that the hollow screw cannot be released or removed from the nut element in a screwing manner. This disassembling protection thus provides a preferred guarantee for the technician or worker that even in case of a too large distance between the two components, an attempt of the tolerance compensation does not lead to a releasing of the tolerance compensating hollow screw from the nut element in the first component. Consequently, the disassembling protection leads to avoiding unwanted extensions of the cycle time during the installation of the connection between the two components, by avoiding a dismantling of the tolerance compensation arrangement comprised of nut element and hollow screw.

According to a preferred embodiment of the present invention, the annular nut element and the hollow screw are made of plastic material and preferably comprise a glass fiber ratio in the range from 25% to 65%, preferentially 45% to 55% and preferably 50%.

For the purpose of a cost-efficient design of the axial tolerance compensation arrangement, same is preferably made of plastic material by means of a likewise preferred injection molding method. Known plastic materials, e.g. thermoplastic plastic materials, are mechanically sufficiently resilient to be able to serve as a tolerance compensation arrangement. The degree of the mechanical load can additionally be increased by adding a glass fiber ratio to the thermoplastic plastic materials. That way, production and distribution costs can be reduced as the production of tolerance compensation arrangements out of plastic material is lower in price than for example a tolerance compensation arrangement out of metal or a combination of plastic material and metal. Furthermore, the weight of a tolerance compensation arrangement out of plastic material is less than that of the same construction out of metal, for example. This has an effect on subsequent transport and delivery costs but also on the weight of the final connection of the two components when using the axial tolerance compensation arrangement.

Preferably, the disassembling protection of the tolerance compensation arrangement is made of a circumferential shaft wall or at least two axial webs which extend in the axial direction of the hollow screw and are thermically radially expandable, so that at least a free end of the axial webs extends radially beyond an inner diameter of the nut element.

According to a first preferred embodiment of the disassembling protection of the tolerance compensation arrangement, a circumferential shaft wall or two axial webs of the hollow screw opposite to the head of the hollow screw are thermically expanded such that their radial expansion exceeds the inner diameter of the nut element. A thermic expansion preferably takes place by a supply of heat or ultrasonic. That way, the hollow screw can no longer be screwed out from the nut element in a non-destructive manner. Furthermore, due to the thermically generated arrangement of the shaft wall or the axial webs of the disassembling protection, it is achieved that in case of a tolerance compensating unscrewing of the hollow nut from the nut element, the hollow nut blocks in the nut element. Such a screw blockage of the hollow screw indicates the worker to interrupt the further installation process and check the necessity of the tolerance compensation between the two components. That way, before the destructive dismantling of the tolerance compensation arrangement, a test step is preferably demanded which for example avoids an exchange of the tolerance compensation arrangement due to the dismantling into hollow screw and nut element.

According to an alternative configuration, the disassembling protection is comprised of at least two axial webs extending in axial direction of the hollow screw and each extending with a constant or increasing radial width toward a free end.

A further preferred configuration of the present invention provides two axial webs as a disassembling protection, extending with a constant or increasing radial width up to the free end and do not have to be expanded thermically. The axial webs have a radial expansion which in combination with a fastening screw that is screwed between the axial webs achieve a radial expansion going beyond the inner diameter of the nut element. That way, a blockage for the hollow screw is geometrically generated, too, which avoids an unscrewing of the hollow screw out of the nut element.

According to a further preferred embodiment, it is preferred that due to their configuration, the stability of the axial webs leads to an increase of the screwing torque of the fastening screw, the further the fastening screw has been screwed between the axial webs. This increasing torque preferably exceeds a specified installation torque for the fastening screw so that an exceeding of this installation torque is also a signal to the worker that the hollow screw has been screwed on the fastening screw excessively far. Such screwing on the fastening screw signals an unwanted removing between hollow screw and nut element which could possibly lead to a separation of nut element and hollow screw.

It is further preferred that the at least two axial webs have a radial inside and a radial outside, the inner sides of which extend nearly parallel and the outer sides of which extend parallel or radially outwards inclined to a longitudinal axis of the hollow screw. In connection with the tolerance compensation arrangement that has just been described, it is furthermore preferred that at least two axial webs do not include a thread on a radial inside so that the fastening screw is subject to a rotation inhibition by means of the axial webs and/or displaces same more radially outwards than with thread.

In a further preferred configuration of the above-described embodiment, the thermically non-deformable axial webs preferably do not comprise any thread on their radial inside. The lacking thread preferably has the effect that a screwed-in fastening screw displaces these axial webs further radially to the outside. Because the thread webs of the fastening screw cannot engage into the thread grooves provided for this purpose of an inner thread of the axial webs, and thus, they push the axial webs radially further to the outside. This supports the radial expansion of the axial webs so that they exceed an inner diameter of the nut element.

According to a further preferred configuration, the lack of a thread on the radial inside of the axial webs leads to an increase of the screw-in torque of the fastening screw when the fastening screw is screwed in. This screw-in torque preferably exceeds a predetermined threshold value so that this screw-in torque signals a possible defect in the arrangement of both components in combination with the tolerance compensation arrangement. Thus, the worker can preferably interrupt his installation process and check the connection configuration to be established.

According to a further preferred embodiment of the tolerance compensation arrangement, the disassembling protection is made of at least two axial webs extending in axial direction of the hollow screw and on each of which a preferably circumferentially extending radial web is arranged on a radial outside radially outwards.

According to a further preferred embodiment of the axial tolerance compensation arrangement, at least two axial webs are provided as a disassembling protection, which on their radial outside comprise a radial web projecting radially outwards. This projecting radial web, preferably two projecting radial webs facing one another on two axial webs arranged opposite each other, have a radial extension on their own or jointly, which exceeds the inner diameter of the nut element. If a fastening screw has been screwed between the axial webs, these axial webs have sufficient radial stability so that for example, they cannot be pushed radially to the inside by the nut element. Therefore, based on this construction, the radially outward projecting radial webs keep their position which gives the hollow screw a radial extension beyond the inner diameter of the nut element. Thus, the radially outwards projecting radial webs block an unscrewing of the hollow screw from the nut element.

It is furthermore preferred that the radially outwards projecting radial webs also realize an anti-loss security of the hollow screw in the nut element. Because for a preferred transport, the hollow screw is screwed into the nut element and then transported to the customer. If vibrations lead to the hollow screw trying to release itself from the nut element, the radially outwards projecting radial webs prevent a final unscrewing or a final withdrawal from the inner thread of the nut element, even if there is no fastening screw between the two axial webs. The reason is that the radially outwards directed spring force of the axial webs is sufficiently big that by vibrations alone, the radially outwards directed radial webs cannot be pushed to the inside so as to be able to release the hollow screw from the nut element.

Preferably, the at least two radial webs are arranged with respect to one another in a way that they form a circumferentially extending thread web.

According to a further preferred configuration of the above-described radially outwards projecting radial webs on the axial webs of the hollow screw, these radial webs are arranged with respect to one another in a way that they form a joint thread web. This thread web is interrupted and is only formed by the radial webs or radial segments, respectively, on the axial webs, it does, however, preferably extend screwlike on the radial outsides of the axial webs and further preferred as a continuation of the outer thread of the hollow screw. That way, the radially outwards projecting radial webs preferably additionally provide an installation support of the hollow screw in the nut element, beside the anti-loss security and the disassembling security. The segmented thread pitch on the radial outside of the axial webs serves for facilitating a screwing-in of the hollow screw into the nut element in order to provide a pre-installed state of the tolerance compensation arrangement.

According to a further preferred configuration of the present invention, the hollow screw of the tolerance compensation arrangement comprises a metallic thread insert as the fastening thread that is molded into the hollow cylindrical shaft.

According to a further preferred configuration of the present invention, the inner thread of the hollow screw is reinforced with the help of a metallic thread insert. The metallic thread insert forms the basis for higher forces to be transmittable between the fastening screw and the hollow screw. Thus, it is for example preferred that a metallic fastening screw be used in combination with the metallic thread insert in order to increase the fastening forces for the retention of both components to each other via the tolerance compensation arrangement. In this context, the metallic thread insert that is imbedded into the radial inside of the hollow screw transmits arising screw forces between the fastening screw and the thread insert into the surrounding plastic material.

Furthermore, the present invention also discloses a connection of a first component and a second component spaced from same with the tolerance compensation arrangement according to at least one of the above-described configurations and a fastening screw.

According to a further preferred configuration of the connection, the first component has a keyhole geometry in which the nut element is arranged.

Furthermore, the present invention discloses a connection method of a first component with a keyhole geometry with a second component spaced from same with a component opening with a tolerance compensation arrangement according to one of the above-described configurations or a combination of same, comprising the following steps: fastening the annular nut element, having the hollow screw preassembled in it, in the keyhole geometry of the first component, arranging the component opening of the second component opposite to the fastening thread of the hollow screw and screwing in a fastening screw which extends through the component opening into the fastening thread, rotating the fastening screw and by that, corotating the hollow screw until same abuts the second component and tightening the fastening screw in the fastening thread when the head of the hollow screw rests against the second component.

Furthermore, the present invention comprises a manufacturing method of the tolerance compensation arrangement according to one of the above configurations comprising the following steps: providing an injection mold for the nut element and for the hollow screw, injection molding the nut element and the hollow screw, demolding the nut element and the hollow screw, pre-installing the hollow screw in the nut element.

### 4. SHORT DESCRIPTION OF THE DRAWINGS

The preferred embodiments of the present invention are described in more detail with reference to the accompanying drawings. They show:

FIG. 1 an exploded view of a preferred configuration of the hollow screw and the nut element of the axial tolerance compensation arrangement,

FIG. 2 the preferred hollow screw and the nut element according to FIG. 1 in a pre-installed state,

FIG. 3 a preferred embodiment of a keyhole geometry for receiving and fastening the nut element,

FIG. 4 an axial sectional view of a preferred embodiment of a hollow screw in combination with the nut element in a pre-installed state,

FIG. 5 a sectional view of the preferred combination of nut element and hollow screw with a tool for thermically expanding the preferred disassembling protection,

FIG. 6 a combination of preferred hollow screw and nut element with a thermically expanded disassembling protection at an axial end of the hollow screw,

FIG. 7 a sectional view of two components to be connected to each other with the help of the preferred axial tolerance compensation arrangement and a fastening screw,

FIG. 8 a sectional view of a connection of two components with the help of the preferred axial tolerance compensation arrangement and a fastening screw,

FIG. 9 a further preferred embodiment of a hollow screw in combination with a nut element in an exploded view,

FIG. 10 the preferred configuration of the hollow screw and the nut element according to FIG. 9 in a pre-installed state,

FIG. 11 two components distanced from each other in the process of connecting with the preferred axial tolerance compensation arrangement with the help of a fastening screw,

FIG. 12 two components distanced from each other, which are connected with the preferred axial tolerance compensation arrangement and a fastening screw,

FIG. 13 a further preferred embodiment of the hollow screw and the nut element in an exploded view,

FIG. 14 the hollow screw and the nut element of FIG. 13 in a pre-installed state,

FIG. 15 two components distanced from each other, which are connected to each other with the preferred axial tolerance compensation arrangement and a fastening screw,

FIG. 16 two components distanced from each other, which are connected to each other with the inventively preferred tolerance compensation arrangement and a fastening screw,

FIG. 17 a combination of a further preferred embodiment of the hollow screw and the nut element in the preinstalled state,

FIG. 18 an enlarged perspective view of a further preferred configuration of the hollow screw,

FIG. 19 a preferred embodiment of the nut element in a perspective view,

FIG. 20 two components at a distance to each other, which are connected to each other with the axial tolerance compensation arrangement according to a preferred embodiment of the present invention and a fastening screw

FIG. 21 two components which are connected to each other with the help of the preferred axial tolerance compensation arrangement and a fastening screw at a distance to each other,

FIG. 22 a flow chart of a preferred embodiment of a connection method by using the axial tolerance compensation arrangement,

FIG. 23 a flow chart of a preferred embodiment of a manufacturing method of the inventive axial tolerance compensation arrangement.

### 5. DETAILED DESCRIPTION OF THE PREFERRED EMBODIMENTS

FIG. 1 shows an exploded view of a preferred embodiment of the axial tolerance compensation arrangement 1 comprised of a nut element 10 and a hollow screw 40.

Preferably, the nut element 10 is configured annularly in order to fasten same in a suitable component opening O1 of a first component A. According to the illustrated preferred configuration in FIG. 1, the nut element 10 has a bayonet structure which is described further below, with which it is fastenable in a keyhole geometry 90 of the component A. For this purpose, in the known manner, the keyhole geometry 90 has at least two cutouts 92 which are evenly distributed circumferentially. The cutouts 92 are adapted to the nut element 10 so that two bayonet webs 12 which project radially from the nut element 10 to the outside are insertable through the cutouts 92 so that they are then capable of locking the nut element 10 at the first component A by means of rotation. In the fastened stated, the first component A is frictionally held between the bayonet webs 12 and a bottom side of a retaining collar 14 of the nut element 10, wherein the retaining collar 14 is axially spaced to the bayonet webs 12.

At least one locking web 16 is arranged preferably displaced by 90° with respect to the two bayonet webs 12, preferably two locking webs in case of two bayonet webs. The locking webs 16 are preferably arranged in an inclined manner in the insertion direction RE of the nut element 10. If the nut element 10 is inserted into the keyhole geometry 90, the bayonet webs 12 reach through the cutouts 92. At the same time, the locking webs 16 rest against the surface of the first component A between the cutouts 92 and generate a preferred spring pretension on the nut element 10 opposite to the insertion direction RE.

As soon as the nut element 10 has been rotated around its longitudinal axis, the bayonet webs 12 lock at a side of the first component A which faces away from the retaining collar 14. While the bayonet webs 12 are rotated out of the cutouts 92 for fastening the nut element 10 in the keyhole 90, the locking webs 16 are preferably rotated into the cutouts 92. Due to the preferred inclined arrangement of the locking webs 16, same lock into the cutouts 92, thereby preventing a future rotation of the nut element 10 around its longitudinal axis.

In order to rotate the nut element 10, the retaining collar 14 is preferably interrupted at least at two locations 15, in order to provide an engagement for a rotating tool.

Preferably, the nut element 10 is annularly configured in combination with the bayonet webs 12 and the locking webs 16.

According to a further preferred embodiment of the nut element 10 (not shown), same comprises an outer thread instead of the bayonet webs 12 and locking webs 16 on a radial outside, so as to be fastened in a thread opening of the first component A.

By that, the annular nut element 10 is screwed into a thread opening of the first component A until the retaining collar 14 rests against the component surface of the first component A. Thus, the outer thread in combination with the retaining collar 14 form a frictional anti-rotation security. This anti-rotation security is provided in the embodiment of FIG. 1 by means of the combination of bayonet webs 12 and locking webs 16 as a form fit anti-rotation security.

According to a further not shown preferred embodiment of the nut element 10, same is formed in circumferential direction triangularly or in a polygonal way so as to be inserted into a component opening in the first component A of a complementary form. The angular form of the nut element 10 provides for an anti-rotation security of the nut element 10 within the component opening O1 relative to the first component A.

In order to retain the angular nut element 10 in the component opening O1, a latching structure (not shown) is provided in the direction of the axial insertion direction R_{E} below the retaining collar 14. The preferred latching structure latches the nut element 10 preferably in a friction-fit and form-fit manner in the component opening O1.

The nut element 10 comprises a passage channel 18, at the radial inside 20 of which an inner thread 22 of a first thread direction is arranged.

A hollow screw 40 comprises a hollow cylindrical shaft 42 with a first and a second axial end. At the first axial end of the shaft 42, a head 44 is provided having a drive feature 46, in particular a hexagon, and an attachment face 48 which faces towards the shaft.

The hollow cylindrical shaft 42 comprises a radial outside 50 with an adjusting thread 52. The adjusting thread 52 matches the inner thread 22 of the nut element 10 and is therefore an adjusting thread 52 of a first thread direction.

The hollow cylindrical shaft 42 comprises an inner channel 54 that is open on both sides and can be seen in the axial sectional view of FIG. 4. A fastening thread 56 of a second thread direction opposite to the first thread direction is arranged at a radial inside of the channel 54.

A disassembling protection 60 of the hollow screw 40 is arranged on the second axial end of the hollow screw 40 opposite the head 44. The function of the disassembling protection 60 in the different preferred embodiments of the present invention is to avoid an unscrewing releasing of the hollow screw 40 from the nut element 10. Such an unscrewing releasing or generally a releasing might for example arise due to vibration during transport of the hollow screw that is preinstalled in the nut element 10.

It is more frequently the case that the situation arises during the connecting of two components A, B and a too large distance T between the two components A, B. If the distance T between the two components A, B exceeds a maximum possible change of length of the tolerance compensation arrangement 1, the automatic tolerance compensation would unscrew and release the hollow screw 40 without interruption from the inner nut thread 22 of the nut element 10.

This unwanted releasing requires an additional effort of repair for the worker as the hollow screw 40 must be re-connected with the nut element 10 and the components A, B must be re-arranged.

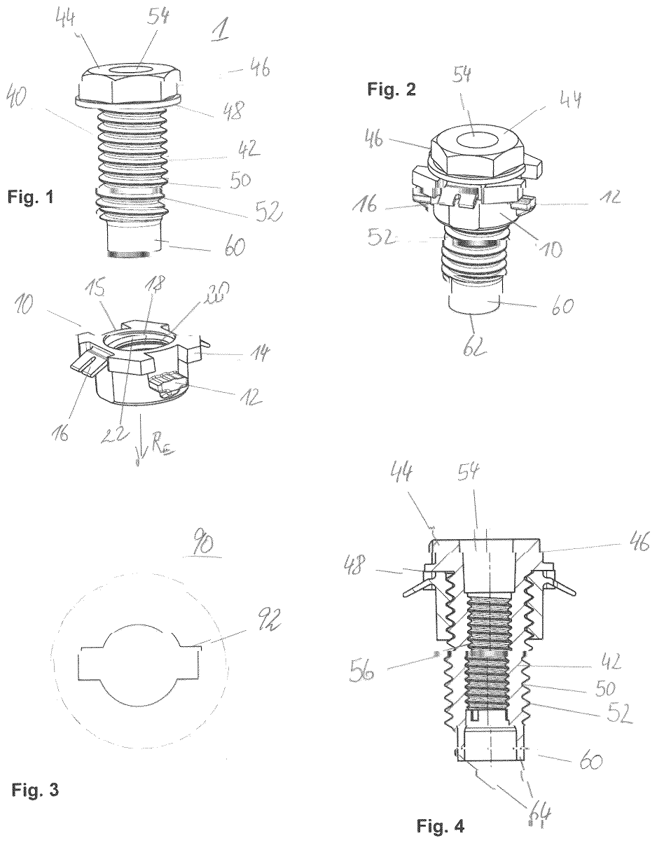

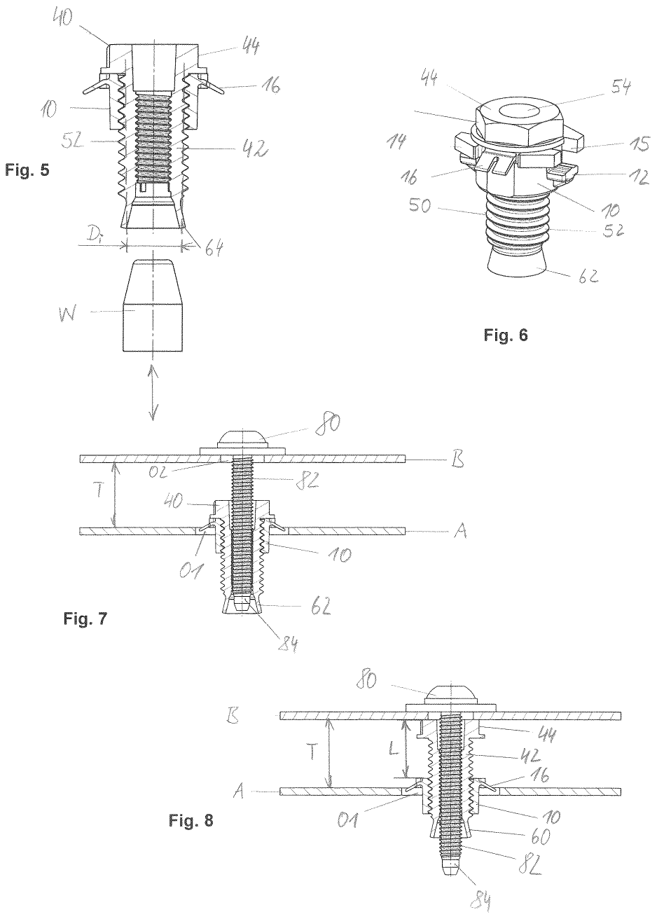

In the preferred embodiment shown in FIGS. 2 and 4 of the present invention, the disassembling protection 60 is comprised of a circumferential shaft wall 62 without thread or of at least two axial webs 64 extending in axial direction of the hollow screw 40. In order to avoid a releasing of the hollow screw 40 from the nut element 10, the circumferential shaft wall 62 or the plurality of axial webs 64 is radially expanded thermically with the help of the preferred conically formed tool W, preferably by means of ultrasonic. Preferably, the radial expansion is carried out up to a radial degree where it exceeds an inner diameter D_{I} of the nut element 10 (see FIG. 5).

The hollow screw 40 is unscrewed from the nut element 10 by means of the rotation of the fastening screw 80 until the disassembling protection 60, here the expanded shaft wall 62 or the thermically expanded axial webs 64 reach the end of the nut element 10 which faces away from the head. In this state, the disassembling protection 60 blocks a further unscrewing of the hollow screw 40 from the nut element 10 due to its radial expansion, as the expanded disassembling protection 60 has an outer diameter that is larger than the inner diameter of the nut element 10.

FIGS. 7 and 8 illustrate the connecting of the first A and the second component B while at the same time compensating axial tolerances between the components A, B with the help of the tolerance compensation arrangement 1. In a first preferred step A, the nut element 10 with the preinstalled hollow screw 40 is fastened in the keyhole geometry 90 of the first component A.

Subsequently, the second component B is arranged with a component opening O2 in a way that the component opening O2 is aligned to the channel 54 of the hollow screw 40 in the nut element 10. In this context, aligned preferably means that a center point of the component opening O2 lies on or adjacent to the central longitudinal axis of the channel 54.

Then, the fastening screw 80 is inserted through the component opening O2 of the second component B into the channel 54 of the hollow screw 40 and rotated in the second thread direction, as the screw thread 82 of the fastening screw 80 has the same thread direction as the fastening thread 56 within the hollow screw 40.

As the fastening thread 56 and the screw thread 82 match geometrically, the fastening screw 80 is screwable into the fastening thread 56 until the end of the screw shaft 84 which faces away from the head reaches a threadless dragging portion 58, which increases a frictional resistance between the rotating fastening screw 80 and the hollow screw 40 in comparison with the threaded engagement between screw thread 82 and fastening thread 56 (step B).

Based on the increasing friction between the fastening screw 80 and the hollow screw 40, the hollow screw 40 is corotated by the fastening screw 80. As the fastening screw 80 corotates the hollow screw 40 in the second thread direction, the hollow screw 40 is however guided in the inner thread 22 of the first thread direction with the adjusting thread 52, the rotation of the fastening screw 80 unscrews the hollow screw 40 in the direction of the second component B from the nut element 10 (step C).

As soon as the head 44 of the hollow screw 40 attaches the second component B, the rotation of the fastening screw 80 overcomes the dragging portion 56 and screws itself firmly with the hollow screw 40.

In case a distance T between the components A, B is larger than a length L which is at most adjustable with the tolerance compensation arrangement 1, and thus bridgeable, the rotating of the fastening screw 80 could release the hollow screw 40 from the nut element 10.

This releasing is, however, prevented by the disassembling protection 60, as due to the radial expansion of the disassembling protection 60, the hollow screw 40 cannot be screwed out from/into the nut element 10.

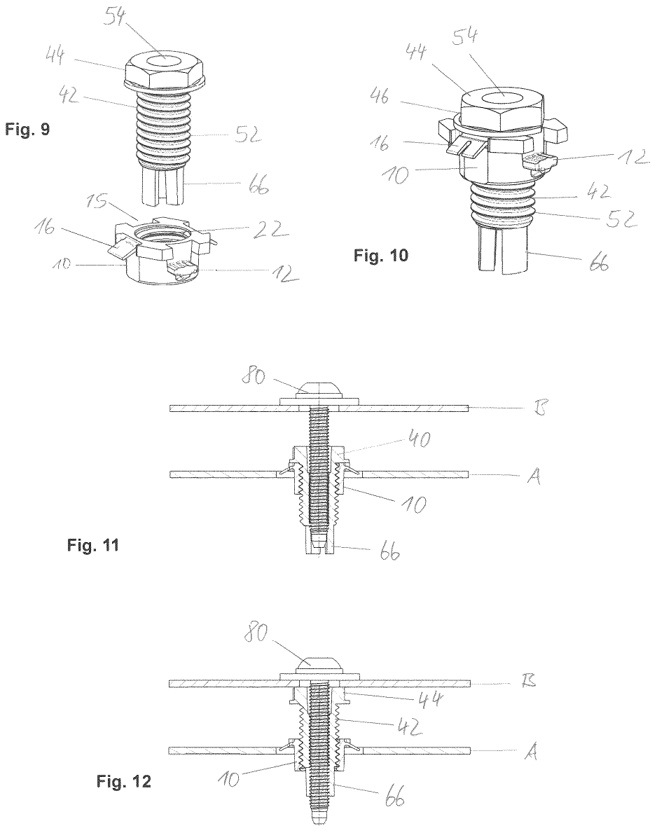

Two further preferred embodiments of the disassembling protection 60′, 60″ of the hollow screw 40 are shown in FIGS. 9-12 and 13-16. Apart from the disassembling protection 60, the construction of the nut element 10 and the hollow screw 40 corresponds to the above-described configurations with reference to FIGS. 1-8.

The disassembling protection 60′of FIGS. 9-12 includes at least two axial webs 66. They extend in a direction facing away from the head of the hollow cylindrical shaft 42 of the hollow screw 40′. Preferably, at least two axial webs 66 are arranged in circumferential direction of the hollow cylindrical shaft 42 in an evenly spaced manner with respect to one another. It is also preferred that three, four or five axial webs 66 be used.

Based on the sectional views of FIGS. 11 and 12, it can be recognized that the axial webs 66 extend with constant or increasing radial width in a direction facing away from the head. The result, at least according to the second alternative, is a preferred conical extension of the axial webs 66, with a thinner end attaching the hollow cylinder 42 and a thicker, free end.

It is furthermore preferred that individual or all axial webs 66 do not include a thread on a radial inside. As can be seen based on FIG. 11, the free end 84 of the fastening screw 80 which faces away from the head is firstly screwed up to the axial end of the fastening thread 56. Due to the increasing screwing resistance for the fastening screw 80 in the disassembling protection 60′, i.e. during screwing in the fastening screw 80 between the axial webs 66, the hollow screw 40′ rotates conjointly with the fastening screw 80. Due to the co-rotation of the hollow screw 40′ and the thread pairing of the first thread direction between nut element 10 and adjusting thread 52 of the hollow screw 40′, the head 44 is screwed into abutment with the second component B. After that, the tightening of the fastening screw 80 in the hollow screw 40′ takes place.

In case the distance T, i.e. the tolerance between the two components A, B to be compensated, is larger than the maximum supporting length L achievable with the nut element 10 and the hollow screw 40′ of the tolerance compensation arrangement 1, the fastening screw 80 could be unscrewed from the disassembling protection 60′.

The fastening screw 80 pushes the axial webs 66 radially to the outside until the outer diameter arising from same of the disassembling protection 60′ with fastening screw 80 extends beyond the inner diameter of the nut element 10 and prevents an unscrewing of the hollow screw 40 from the nut element 10.

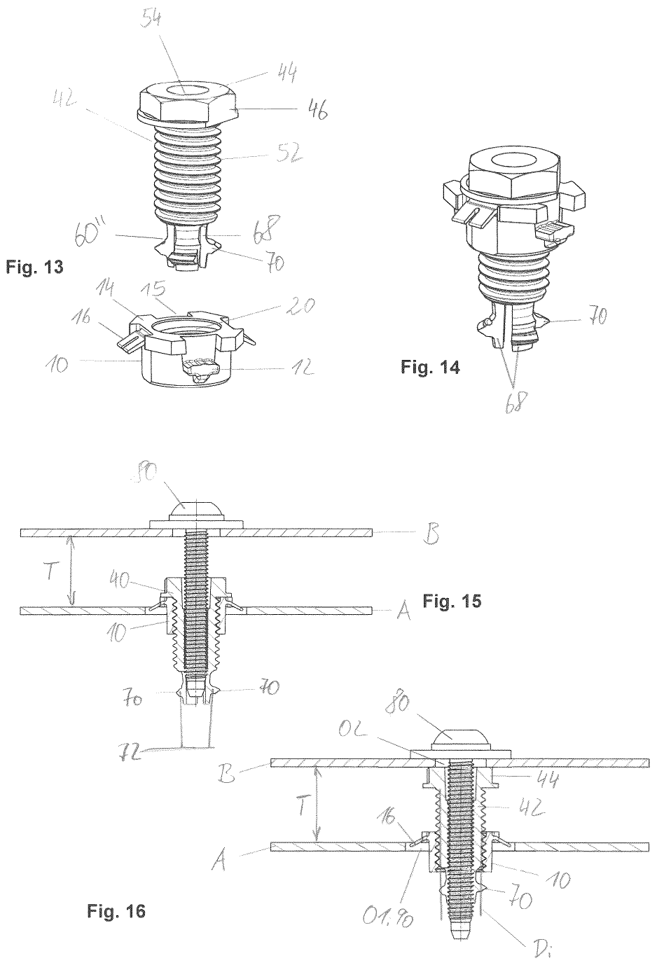

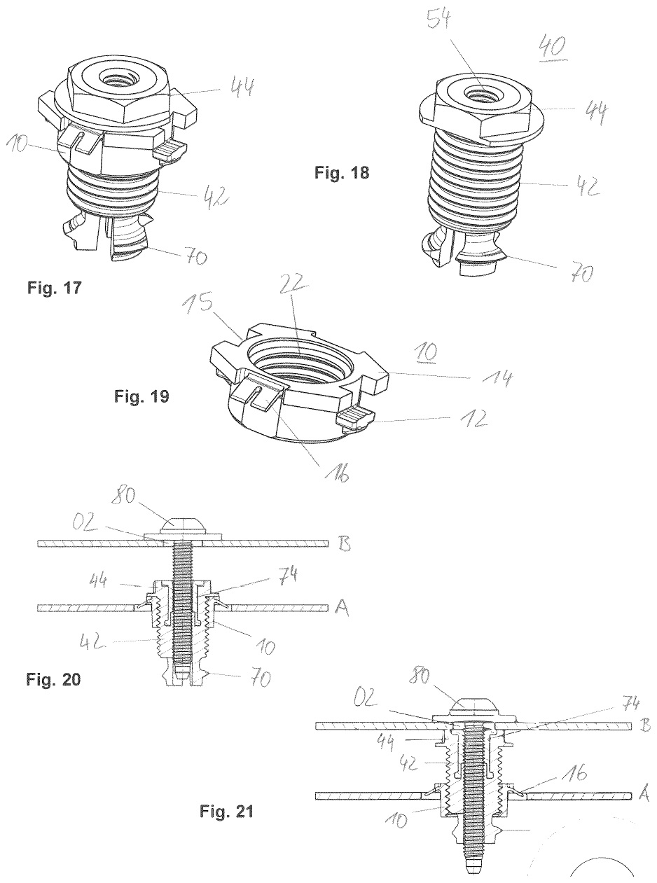

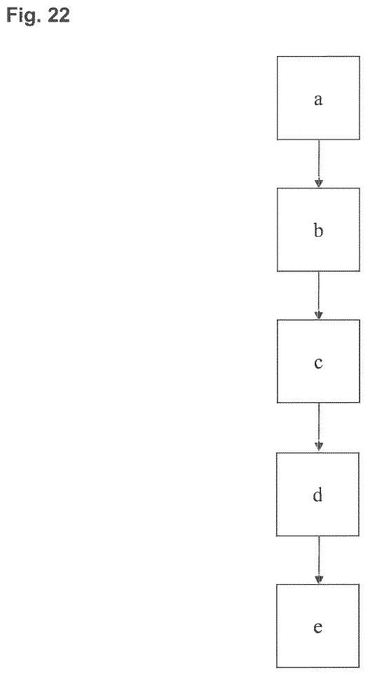

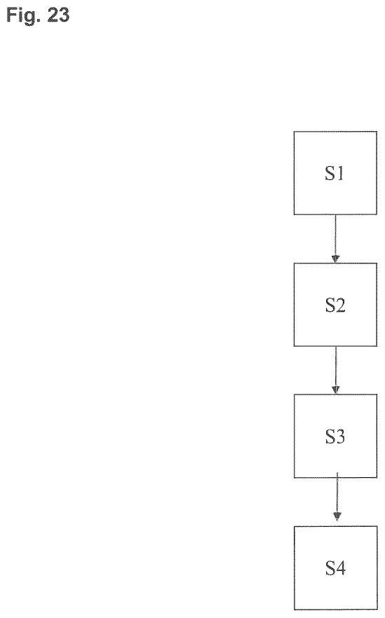

In FIGS. 13-16, a further preferred embodiment of the axial tolerance compensation arrangement 1 is shown, which differentiates from the previously described embodiments of the present invention by the disassembling protection 60″. As can be seen in FIGS. 13-16, axial webs 68 extend from the hollow cylindrical shaft 42 in a direction of the hollow screw 40 which faces away from the head.

These axial webs 68 have a constant radial thickness or a decreasing radial thickness, preferably in the direction of the free end, i.e. a conical shape. Furthermore, the axial webs 68 are arranged evenly distributed with respect to the hollow cylindrical shaft 42.

It is furthermore preferred that the axial webs 68 are formed like strips with a constant width in circumferential direction. It is also preferred that the width decreases towards the free end, so as to increase a elastic deformability of the axial webs 68.

While a radial inside of the axial webs 68 is preferably designed without a thread, each radial outside has one radially outwards projecting radial web 70.

The radial webs 70 have a preferred radial extension beyond an inner diameter of the inner thread 22 of the nut element 10. The fastening screw 80 is screwed into the fastening thread 56 and the hollow screw 40″ is displaced in the direction of the second component B when the screw shaft 84 is screwed into the disassembling protection 60″ by means of the adjusting thread 52 and the nut element 10. The preferred radial expansion of the radial webs 70 of the disassembling protection 60″ blocks a possible unscrewing of the hollow screw 40″ from the nut element 10.

Preferably, the axial webs 68 are configured in a radially elastic manner. Preferably, this arrangement facilitates an inserting of the hollow screw 40″ into the nut element 10, as in order to pass the passage channel 18 of the nut element 10, the axial webs 68 with the radial webs 70 arranged on them may be pushed elastically radially to the inside. After passing the passage channel 18, the axial webs 68 with the radial webs 70 spring back radially to the outside in order to prevent, as a disassembling protection 60″, a passing of the nut element 10.

According to a further preferred embodiment of the present invention, the preferred radial webs 70 are arranged with respect to each other in a way that they form an axially interrupted thread web 72 which extends circumferentially around a longitudinal axis of the hollow screw 40″. This is indicated in FIG. 15 in which the two radial webs 70 opposite one another are arranged in an axially displaced manner with respect to each other, so as to form the segmented thread web 72.

The segmented thread web 72 preferably facilitates the connecting of the nut element 10 and the hollow screw 40″, as with the help of the segmented thread web 72, the hollow screw 40″ may be installed easier in the nut element 10 by means of the disassembling protection 60″ than without segmented thread web 72. In this case, segmented thread web 72 means that the thread web is comprised of a plurality of segments wherein one of each is arranged on an axial web 68. According to a further preferred embodiment, the segmented thread web 72 is formed complementary with respect to the inner thread of the nut element 10. Based on this constructive basis, the disassembling protection 60″ with the segmented thread web 72 may be screwed through the nut element 10 by means of engagement into the inner thread 22 of the nut element 10, so as to be pre-installed with less effort.

According to a further preferred embodiment of the invention, the hollow screw 40″ comprises a metallic thread insert 74 for reinforcing the fastening thread 56.

As the nut element 10 and the hollow screw 40; 40′; 40″ of all preferred embodiments of the present invention are preferably manufactured with the help of an injection molding method out of plastic material, the metallic thread insert 74 guarantees a reinforcement of the fastening thread 56 of the hollow screw 40; 40′; 40″ and is arrangeable in the hollow screw 40 with less effort during the injection molding method.

As the fastening screw 80 is preferably also made of metal, mechanical loads may be removed by means of a metal-metal-threaded connection and introduced into the material of the hollow screw 40; 40′; 40″.

In order to increase a mechanical resilience of the plastic parts of the axial tolerance compensation arrangement 1; 1′; 1″, it is preferred that a glass fiber ratio of 25% to 65%, preferably 45% to 55% and further preferred 50% is added to the plastic that is processed in the injection molding.

The present invention also comprises the connection of two components A, B with the help of the inventively preferred axial tolerance compensation arrangement 1. For example, such connections with the different preferred embodiments of the axial tolerance compensation arrangement 1 are schematically illustrated in FIGS. 8, 12, 16 and 21.

The connection method for connecting the two components A, B with the help of the axial tolerance compensation arrangement 1 may be summarized with the following steps. Fastening (step a) the nut element 10 with a hollow screw 40 preassembled in it in a first component opening O1, preferably a preferred keyhole geometry of the first component A, arranging (step b) the component opening O2 of the second component B opposite the fastening thread of the hollow screw 40 and screwing in (step c) the fastening screw 80, which extends through the component opening O2, into the fastening thread. After that, a lengthening of the tolerance compensation arrangement 1 in axial direction takes place by rotating (step d) the fastening screw 80 and the associated co-rotating of the hollow screw 40, until the tolerance compensation arrangement 1 attaches the second component B with the head 42 of the hollow screw 40. Finally, in step e, the fastening screw 80 is tightened in the fastening thread of the hollow screw 40 when the head 42 of the hollow screw 40 rests against the second component B.

As already mentioned above, the components of the axial tolerance compensation arrangement 1 are preferably made of plastic material, specifically the nut element 10 and the hollow screw 40 in their different, preferred configurations. It is additionally preferred that a glass fiber ratio (see above) be added to the used plastic material for the manufacture of the nut element 10 and the hollow screw 40 in order to increase its mechanical resilience and stability.

According to a preferred embodiment of the present invention, the nut element 10 and the hollow screw 40 are manufactured with the help of an injection molding method. Accordingly, the manufacturing method can be summarized with the following steps: providing (step S1) an injection mold for the nut element 10 and for the hollow screw 40, injection molding (step S2) the nut element 10 and the hollow screw 40, demolding (step S3) the nut element 10 and the hollow screw 40 and pre-installing (step S4) the hollow screw 40 in the nut element 10.

The step of pre-installing (step S4) is no mandatory part of the manufacturing method and can take place later depending on the installation process of the axial tolerance compensation arrangement 1.

### 6. LIST OF REFERENCE SIGNS

1 axial tolerance compensation arrangement
10 nut element
12 bayonet web
14 retaining collar
15 breakthrough as tool engagement
16 locking web
18 passage channel in the nut element
20 radial inside in the passage channel 18
22 inner thread of a first thread direction
40 hollow screw
42 hollow cylindrical shaft
44 head
46 drive feature
48 attachment surface
50 radial outside of the shaft 42
52 adjusting thread of a first thread direction
54 channel
56 fastening thread of a second thread direction
58 dragging portion
60 disassembling protection
62 circumferential shaft wall
64 axial webs
66 axial webs
67 radial inside of the axial webs 66
68 axial webs
70 radial web
72 segmented thread web
74 metallic thread insert
80 fastening screw
82 screw thread
84 screw shaft
90 keyhole geometry
A first component
B second component
O1 component opening in the first component
O2 component opening in the second component
R_{E} insertion direction
W thermic tool or by means of ultrasonic
D_{I} inner diameter of the nut element
T distance/tolerance between the components A, B
L maximum length of the tolerance compensation arrangement

1. An axial tolerance compensation arrangement for the automatic compensation of tolerances between a first component and a second component, comprising:
a. a nut element with a radially outer fastening structure which is fastenable in a component opening of the first component, and an inner nut thread of a first thread direction,
b. a hollow screw with a head and a hollow-cylindrical shaft having an adjustment thread at a radial outside matching the nut thread and a fastening thread with a second thread direction opposite to the first thread direction at a radial inside, wherein the fastening thread interacts with
c. a fastening screw of a second thread direction so that the first and the second component are fastenable to one another by means of the tolerance compensation arrangement, wherein
d. the hollow-cylindrical shaft comprises a disassembling protection at an axial end which faces away from the head, wherein with the disassembling protection an unscrewing of the hollow screw from the nut element during an installation of the tolerance compensation arrangement is prevented.

2. The tolerance compensation arrangement according to claim 1, in which the annular nut element and the hollow screw are made of plastic material.

3. The tolerance compensation arrangement according to claim 1, in which the disassembling protection comprises a circumferential shaft wall or at least two axial webs which extend in axial direction of the hollow screw and are thermically radially expandable, so that at least a free end of the shaft wall or the axial webs extends radially beyond an inner diameter D_{I} of the nut element.

4. The tolerance compensation arrangement according to claim 1, in which the disassembling protection is comprised of at least two axial webs extending in axial direction of the hollow screw and each extending with a constant radial width or extending conically with an increasing radial width toward a free end.

5. The tolerance compensation arrangement according to claim 4, the at least two axial webs of which have a radial inside and a radial outside, the inner side of which extends nearly parallel and the outer side of which extends radially outwards inclined to a longitudinal axis of the hollow screw.

6. The tolerance compensation arrangement according to claim 5, the at least two axial webs of which do not comprise any thread on a radial inside so that the fastening screw is subject to a rotation inhibition by the axial webs and/or displaces them more radially to the outside than with thread.

7. The tolerance compensation arrangement according to claim 1, in which the disassembling protection comprises at least two axial webs extending in axial direction of the hollow screw and each having radially outwards a radial web arranged on a radial outside.

8. The tolerance compensation arrangement according to claim 7, in which at least two radial webs are arranged with respect to each other in a way that they form a circumferentially extending thread web.

9. The tolerance compensation arrangement according to claim 1 in which the fastening thread of the hollow screw in the form of an overmolded metallic thread insert is molded into the hollow cylindrical shaft.

10. A connection of a first component and a second component spaced from same using the tolerance compensation arrangement according to claim 1 and a fastening screw.

11. The connection according to claim 10 in which the first component comprises a keyhole geometry in which the nut element is arranged.

12. A connection method of a first component with a keyhole geometry with a second component spaced from same with a component opening with the tolerance compensation arrangement according to claim 1, comprising the following steps:
a. fastening the nut element having the hollow screw preassembled in the opening of the first component,
b. arranging the component opening of the second component opposite to the fastening thread of the hollow screw and screwing in a fastening screw which extends through the component opening into the fastening thread,
c. rotating the fastening screw and by that, corotating the hollow screw until same abuts the second component and
d. tightening the fastening screw in the fastening thread when the head of the hollow screw rests against the second component.

13. (canceled)
